(19) United States
(12) Patent Application Publication
(10) Pub. No.: US 2007/0113675 A1
(43) Pub. Date: May 24, 2007

(54) Circuit board clamping mechanism and testing device using the same

(75) Inventor: Chun-Yi Cheng, Taipei (TW)

Correspondence Address: RABIN & Berdo, PC, 1101 14TH STREET, NW, SUITE 500, WASHINGTON, DC, 20005, US

(73) Assignee: ASUSTek COMPUTER INC., Taipei (TW)

(21) Appl. No.: 11/528,663

(22) Filed: Sep. 28, 2006

(30) Foreign Application Priority Data
Nov. 4, 2005 (TW) 094138848

(51) Int. Cl. G01N 3/02

(52) U.S. Cl. 73/856

(57) ABSTRACT

A circuit board clamping mechanism and a testing device using the same. The circuit board clamping mechanism is for clamping a main circuit board and an extending circuit board. The extending circuit board is coupled with the main circuit board, and there is a titling angel between the extending circuit board and the main circuit board. The circuit board clamping mechanism includes a substrate board and a clamping element. The main circuit board is disposed on the substrate board. The clamping element includes a clamping part and a fixing part. The clamping part is for clamping the extending circuit board. The fixing part is disposed on the substrate board and is coupled with the clamping part. The clamping part and the fixing part form an L-shaped structure.

This application claims the benefit of Taiwan application Serial No. 094138848, filed Nov. 04, 2005, the subject matter of which is incorporated herein by reference.

### BACKGROUND OF THE INVENTION

1. Field of the Invention

The invention relates in general to a circuit board clamping mechanism and a testing device using the same, and more particularly to a circuit board clamping mechanism firmly clamping an extending circuit board on a main circuit board by an L-shaped clamping element and a testing device using the same.

2. Description of the Related Art

Electronic products have brought great convenience to modern people in their daily life and work. Computer in particular has become an indispensable necessity in people's everyday life. Computer includes a host and a screen. The host further includes a main circuit board and at least an extension circuit board such as the display circuit board (VGA circuit board). The display circuit board is inserted or soldered to be coupled with the main circuit board. For example, the display circuit board is vertically inserted into the slot of the main circuit board. During the delivery of the host, when the host receives vibration or strong impact, the main circuit board and the display circuit board might be separated or cracking might occur to the soldering connection between the main circuit board and the display circuit board. Therefore, before a computer host leaves the factory, a series of vibration and impact tests are performed to assure that the display circuit board and the main circuit board remain intact after vibration or impact and their electrical functions are normal.

Conventional vibration or shock testing device provides a housing and a vibrational source or the shocking source. The shocking source provides a strong vibration within a short period of time. The disclosure below is exemplified by a vibration testing device and a vibrational source. The main circuit board is clamped on the housing, and the display circuit board is vertically inserted in the main circuit board. At the beginning, the vibrational source applies a vibrational force onto the housing, then the vibrational force is transmitted to the main circuit board via the housing first and transmitted to the display circuit board via the main circuit board next. The above design tests whether the display circuit board and the main circuit board coupled with the same still remain normal electrical functions during vibration.

However, the vibrational force decays when transmitted from the housing to the main circuit board and the display circuit board in sequence. The vibrational force actually received by the display circuit board is very different from the vibrational force predetermined to be received by the display circuit board, largely affecting the accuracy of vibration testing which may further affects product quality. The accuracy problem not only occurs to the vibration test of the display circuit board and the main circuit board but also occurs to the vibration test of any two circuit boards coupled together. Thus, how to provide a testing environment for the vibrational or shocking test of any two coupled circuit boards is an imminent issue with respect to the quality control of electronic products.

### SUMMARY OF THE INVENTION

It is therefore an object of the invention to provide a circuit board clamping mechanism and a testing device using the same. The design of positioning the main circuit board by a substrate board and directly clamping the extending circuit board on the substrate board by a clamping element of the substrate board not only firmly clamps the extending circuit board and the main circuit board together but also accurately transmit the vibration or impact provided by a vibrational source or a shocking source onto the extending circuit board. Thus, the electrical functions of the extending circuit board and the main circuit board under a vibrational or a shocking state can be accurately measured such that the quality of electronic products is assured.

The invention achieves the above-identified object by providing a circuit board clamping mechanism for clamping a main circuit board and an extending circuit board. The extending circuit board is coupled with the main circuit board, and there is a titling angel between the extending circuit board and the main circuit board. The circuit board clamping mechanism includes a substrate board and a clamping element. The main circuit board is disposed on the substrata board. The clamping element includes a clamping part and a fixing part. The clamping part is for clamping the extending circuit board. The fixing part is disposed on the substrate board and is coupled with the clamping part. The clamping part and the fixing part form an L-shaped structure.

The invention further achieves the above-identified object by providing a testing device for testing the electrical functions of an extending circuit board under a vibrational state or a shocking state. The testing device includes a substrate board, a main circuit board, a clamping element, a testing platform and an inspecting unit. The main circuit board is disposed on the substrate board. The main circuit board is coupled with the extending circuit board, and there is a titling angel between the main circuit board and the extending circuit board. The clamping element includes a clamping part and a fixing part. The clamping part is for clamping the extending circuit board. The fixing part is disposed on the substrate board and is coupled with the clamping part. The clamping part and the fixing part form an L-shaped structure. The testing platform is coupled with the substrate board for providing a vibrational source or a shocking source to the substrate board. The inspecting unit is electrically connected to the extending circuit board and the main circuit board for inspecting the electrical functions of the extending circuit board under the vibrational state or the shocking state.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a testing device according to a preferred embodiment of the present embodiment of the invention; and

FIG. 2 is a structural diagram of a testing platform.

### DETAILED DESCRIPTION OF THE INVENTION

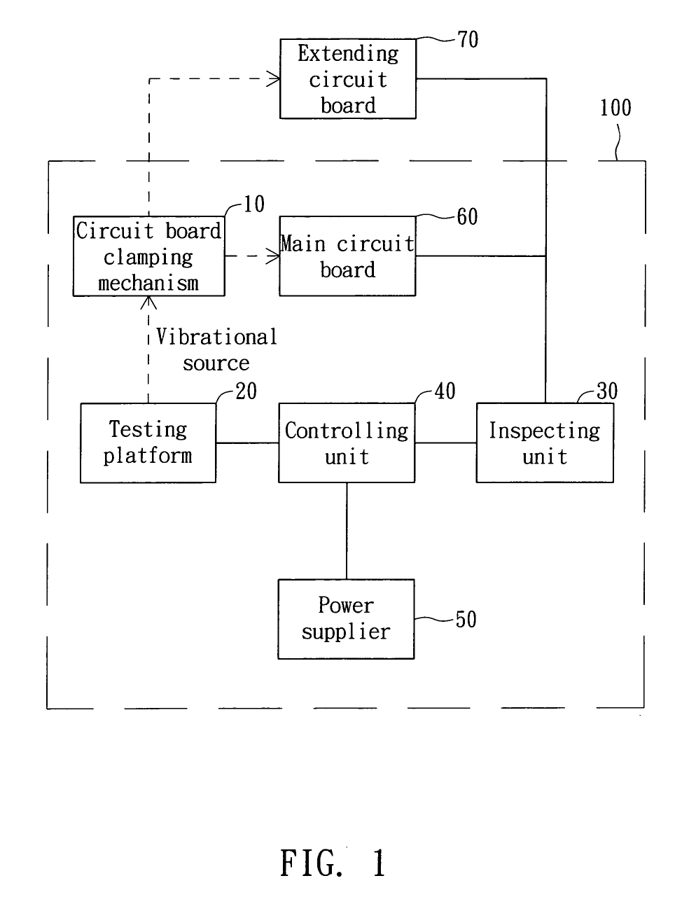

Referring to FIG. 1, a block diagram of a testing device according to a preferred embodiment of the present embodiment of the invention is shown. The testing device 100 is for testing the electrical functions of an extending circuit board 70 under a vibrational state or a shocking state. The testing platform 20 is for generating a vibrational source or a shocking source for testing. In the present embodiment of the invention, the testing platform 20 is exemplified by providing a vibrational source to a circuit board clamping mechanism 10 by a vibrator. The circuit board clamping mechanism 10 is for clamping a main circuit board 60 and an extending circuit board 70, and transmitting the vibrational force to the main circuit board 60 and the extending circuit board 70. The main circuit board 60 is coupled with the extending circuit board 70. Examples of the main circuit board 60 include a computer main circuit board, an optical disc drive main circuit board or a mobile communication main circuit board. Examples of the extending circuit board 70 include a display circuit board, an Ethernet circuit board or a sound circuit board. In the present embodiment of the invention, the main circuit board 60 is exemplified by a computer main circuit board, and the extending circuit board 70 is exemplified by a display circuit card. The main circuit board 60 and the extending circuit board 70 are further electrically connected to an inspecting unit 30. The inspecting unit 30 is for inspecting the electrical functions of the main circuit board 60 and the extending circuit board 70 under a vibrational state. Examples of the inspecting unit 30 include a monitor screen or an electrical signal inspection chip. The testing device 100 further includes a controlling unit 40 for driving the testing platform 20 and the inspecting unit 30. The controlling unit 40 is powered by a power supplier 50.

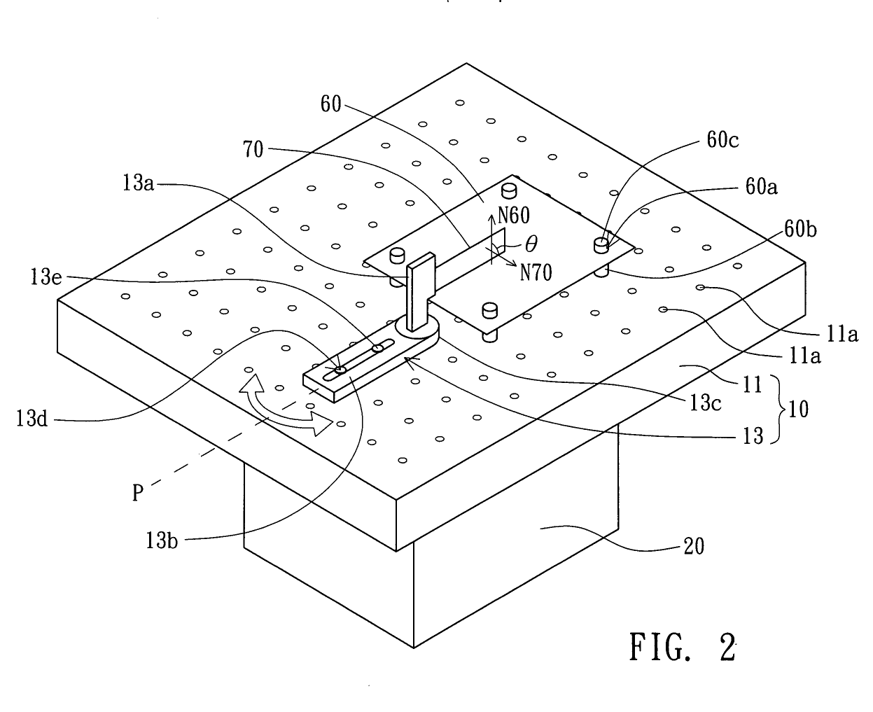

Referring to FIG. 2, a structural diagram of a testing platform is shown. The testing platform 20 is coupled with the circuit board clamping mechanism 10, such that the testing platform 20 can transmit a vibrational force to the circuit board clamping mechanism 10. The circuit board clamping mechanism 10 includes a substrate board 11 coupled with the testing platform 20 and the main circuit board 60 for transmitting the vibrational force provided by the testing platform 20 to the main circuit board 60. In the present embodiment of the invention, the testing platform 20 is coupled with the substrate board 11 and is disposed under the substrate board 11. The main circuit board 60 has a number of screw holes. For example, the main circuit board 60 has four screw holes 60a respectively disposed at the four corners of the main circuit board 60. The substrate board 11 has a number of positioning holes 11a arranged in matrix form. The circuit board clamping mechanism 10 further includes a number of the bolts 60b and the nuts 60c respectively connecting the screw hole 60a and the positioning hole 11a for screwing the main circuit board 60 on the substrate board 11, wherein the positioning hole 11a correspond to the screw hole 60a. Normally, a number of transistors or electronic elements are disposed on the two side of the main circuit board 60. By elevating the main circuit board 60 by a number of bolts 60b of the same height, the electronic elements disposed on the side near the substrate board 11 are prevented from colliding with the substrate board 11 directly. Furthermore, the substrate board 11 has a number of positioning holes 11a arranged in matrix form such that the main circuit board 60 can be of various sizes and the testing device 100 becomes more flexible in terms of usage.

Despite the connection between the main circuit board 60 and the substrate board 11 is exemplified by screwing the bolt 60b and the nut 60c in the present embodiment of the invention, the connection between the main circuit board 60 and the substrate board 11 can be achieved by ways of other lock joint, buckle joint, dowel joint, adhesive joint, cup joint, bolt joint or rivet joint.

The main circuit board 60 is coupled with the extending circuit board 70. In the present embodiment of the invention, the extending circuit board 70 is vertically inserted into the slot of the main circuit board 60, and there is a tilting angle θ of 90 degrees between the normal line N60 of the main circuit board 60 and the normal line N70 of the extending circuit board 70.

The extending circuit board 70 is further firmly clamped on the substrate board 11 via a clamping element 13. The clamping element 13 further includes a clamping part 13a and a fixing part 13b. The clamping element 13 clamps one side of the extending circuit board 70 by the clamping part 13a and is fixed on the substrate board 11 by the fixing part 13b. The clamping part 13a and the fixing part 13b form an L-shaped structure which can be integrally formed in one piece. The clamping element 13 further includes a spindle 13c disposed at the connection between the clamping part 13a and the fixing part 13b. The fixing part 13b rotates around the spindle 13c and moves with respect to the clamping part 13a. For example, the spindle 13c enables the clamping part 13a and the fixing part 13b to rotate relatively and is disposed on the substrate board 11. The substrate board 11 has a number of positioning holes 11a arranged in matrix form. The fixing part 13b further has a bar-shaped fixing opening 13d. When the fixing part 13b rotates around the spindle 13c and move with respect to the clamping part 11a until reaching a screwing position P, the fixing opening 13d corresponds to two positioning holes 1a. The user may penetrate through the fixing opening 13d by two screws 13e to be screwed in the two positioning hole 11a. The substrate board 11 having a number of positioning holes 11a and the fixing opening 13d and the spindle 13c enables the fixing part 13b to rotate and locate a suitable screwing position P to be fixed on the substrate board 11 when the clamping element 13 clamps the extending circuit board 70. The clamping element 13 can be made from a hard material, such as copper, stainless steel or iron, for transmitting the vibrational force provided by the vibrational source to the extending circuit board 70.

According to the above disclosure, after the testing platform 20 provides a vibrational source to a substrate board 11, the substrate board 11 transmits the vibrational force to the extending circuit board 70 via the clamping element 13, such that the vibrational force actually received by the extending circuit board 70 is close to the vibrational force predetermined. Thus, the sensing unit 30 of FIG. 1 is capable of accurately measuring the electrical functions of the extending circuit board 70 under a vibrational state.

According to the above preferred embodiment, despite the clamping element is exemplified by being detachably disposed on the substrate board in the present embodiment of the invention, however, the clamping element can be integrally formed in one piece with the substrate board to be fixed on the substrate board in the present embodiment of the invention. Any designs capable of directly transmitting a vibrational force to the extending circuit board by a circuit board clamping mechanism such that the vibrational force is close to the vibrational force predetermined and the electrical functions of the extending circuit board are accurately measured are within the scope of technology of the invention.

A circuit board clamping mechanism and a testing device using the same are disclosed in above embodiment of the invention. The circuit board clamping mechanism positions the main circuit board by a substrate board and directly clamps the extending circuit board on the substrate board by a clamping element disposed on the substrate board, not only firmly clamping the main circuit board and the extending circuit board, but also accurately transmitting the vibrational force provided by the vibrational source to the extending circuit board. Therefore, the electrical functions of the extending circuit board and the main circuit board coupled together can be accurately measured and the quality of the electronic products can be assured.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A circuit board clamping mechanism for clamping a main circuit board and an extending circuit board, wherein the extending circuit board is coupled with the main circuit board, and there is a titling angel between the extending circuit board and the main circuit board, the circuit board clamping mechanism comprising:
a substrate board on which the main circuit board is disposed thereon; and
a clamping element, comprising:
a clamping part for clamping the extending circuit board; and
a fixing part disposed on the substrate board to be coupled with the clamping part, wherein the clamping part and the fixing part form an L-shaped structure.

2. The circuit board clamping mechanism according to claim 1, wherein the main circuit board is substantially parallel to the substrate board and the fixing part is screwed on the substrate board.

3. The circuit board clamping mechanism according to claim 1, wherein the clamping element further comprises a spindle disposed at the connection between the clamping part and the fixing part, and the fixing part rotates around the spindle and moves with respect to the clamping part.

4. The circuit board clamping mechanism according to claim 3, wherein the substrate board further has a plurality of positioning holes, the fixing part further has a fixing opening, the fixing part rotates around the spindle and moves with respect to the clamping part until reaching an screwing position, such that the fixing opening is positioned above one of the positioning holes, the circuit board clamping mechanism further penetrates through the fixing opening to be screwed into the positioning hole by a screw for screwing the fixing part and the substrate board.

5. The circuit board clamping mechanism according to claim 1, wherein the main circuit board is screwed on the substrate board.

6. The circuit board clamping mechanism according to claim 5, wherein the main circuit board has a plurality of screw holes, the substrate board has a plurality of positioning holes, the circuit board clamping mechanism further respectively screw the screw holes and the positioning holes corresponding to the screw holes by a plurality of bolts for screwing the main circuit board on the substrate board.

7. The circuit board clamping mechanism according to claim 1, wherein the clamping mechanism is made from a hard material.

8. The circuit board clamping mechanism according to claim 1, wherein the extending circuit board is inserted in the main circuit board.

9. The circuit board clamping mechanism according to claim 8, wherein the normal line of the surface of the extending circuit board is perpendicular to the normal line of the surface of the main circuit board.

10. A testing device for testing the electrical functions of an extending circuit board under a vibrational state or a shocking state, the testing device comprising:
a substrate board;
a main circuit board disposed on the substrate board, wherein the main circuit board is coupled with the extending circuit board, and there is a titling angel between the main circuit board and the extending circuit board;
a clamping element, comprising:
a clamping part for clamping the extending circuit board; and
a fixing part disposed on the substrate board and coupled with the clamping part, wherein the clamping part and the fixing part form an L-shaped structure;
a testing platform coupled with the substrate board for providing a vibrational source or a shocking source to the substrate board; and
an inspecting unit electrically connected to the extending circuit board and the main circuit board for inspecting the electrical functions of the extending circuit board under the vibrational state or the shocking state.

11. The testing device according to claim 10, wherein the testing platform further comprises a vibrator or an impactor.

12. The testing device according to claim 11, further comprising:
a controlling unit electrically connected to the vibrator or the impactor for driving the vibrator or the impactor; and
a power supplier electrically connected to the controlling unit for providing the testing device with necessary power.

13. The testing device according to claim 10, wherein the fixing part is screwed on the substrate board.

14. The testing device according to claim 10, wherein the clamping element further comprises a spindle disposed at the connection between the clamping part and the fixing part, and the fixing part rotates around the spindle and moves with respect to the clamping part.

15. The testing device according to claim 14, wherein the substrate board further has a plurality of positioning holes, the fixing part further has a fixing opening, the fixing part rotates around the spindle and moves with respect to the clamping part until reaching an screwing position, such that the fixing opening is positioned above one of the first positioning holes, and the testing device further penetrates through the fixing opening to be screwed into the first positioning hole by a screw for screwing the fixing part and the substrate board.

16. The testing device according to claim 10, wherein the main circuit board is screwed on the substrate board.

17. The testing device according to claim 16, wherein the main circuit board has a plurality of screw holes, the substrate board has a plurality of positioning holes, the extending circuit board clamping mechanism further respectively screw the screw holes and the positioning holes corresponding to the screw holes by a plurality of bolts for screwing the main circuit board on the substrate board.

18. The testing device according to claim 10, wherein the clamping mechanism is made from a hard material.

19. The testing device according to claim 10, wherein the extending circuit board is inserted in the main circuit board.

20. The testing device according to claim 10, wherein the normal line of the surface of the extending circuit board is perpendicular to the normal line of the surface of the main circuit board.
